(19) United States
(12) Patent Application Publication
(10) Pub. No.: US 2025/0069471 A1
(43) Pub. Date: Feb. 27, 2025

(54) COMPUTER-IMPLEMENTED METHOD AND SYSTEM FOR AUTOMATICALLY FOLDING A POKER HAND ACCORDING TO PREDETERMINED CRITERIA

(71) Applicants: Eli Sompo, Jerusalum (IL); Aharon Malachi, Jerusalum (IL)

(72) Inventors: Eli Sompo, Jerusalum (IL); Aharon Malachi, Jerusalum (IL)

(21) Appl. No.: 18/811,659

(22) Filed: Aug. 21, 2024

Related U.S. Application Data
(60) Provisional application No. 63/520,811, filed on Aug. 21, 2023.

(51) Int. Cl. G07F 17/32

(52) U.S. Cl. CPC G07F 17/323; G07F 17/3293

(57) ABSTRACT

According to an aspect of the present invention, there is provided computer-implemented method for automatically folding poker hands, comprising: displaying, on a graphical user interface at a player computer terminal, a matrix of potential poker hands; receiving, from the player computer terminal, a set of instructions from the player to automatically fold a subset of the matrix of potential poker hands; comparing, by a processor, the set of instructions to a poker hand of a player; and executing an instruction, by a processor, to automatically fold the poker hand of the player.

### BACKGROUND

Poker is a well-known card game that comes in many variations. A feature common to most poker games is that the ranking of the final hands is based on poker hand ranking. A typical poker hand ranking, from highest to lowest by poker hand category, is: Royal Flush, Straight Flush, Four-of-a-Kind, Full House, Flush, Straight, Three-of-a-Kind, Two Pair, One Pair, and Highest Card in Hand. Often 2-10 players compete in a communal format to see who has the highest hand, although single-player games involving e.g., video poker terminals are also common.

Sometimes poker games take place at a venue, such as a casino, where all of the players physically gather together to participate. Often internet-based poker games are organized as well and played utilizing home computers or mobile devices and web-browsers or mobile applications. These games allow geographically disparate players to participate in poker games without having to travel to a particular venue.

### SUMMARY OF INVENTION

Therefore, the present invention can be implemented either in a poker game where all of the players are physical gathered on an adjacent computerized device or in an internet-based poker game.

A well-known determinant of success in poker and metric for measuring the skill of a poker player is the propensity of a poker player to fold a hand in disadvantageous situations. Poor poker players tend not to fold when it is advantageous to do so and end up sustaining losses playing hands that would have been better to fold. It is also difficult for a poker player to be disciplined enough to fold a hand since it may be more entertaining to continue to play the hand. A set of rules for when a poker hand should be folded is thus desirable.

Accordingly, an aspect of the present invention provides a computer-implemented method for automatically folding poker hands, comprising: displaying, on a graphical user interface at a player computer terminal, a matrix of potential poker hands; receiving, from the player computer terminal, a set of instructions from the player to automatically fold a subset of the matrix of potential poker hands; comparing, by a processor, the set of instructions to a poker hand of a player; and executing an instruction, by a processor, to automatically fold the poker hand of the player.

According to another aspect of the present invention, there is provided a system, comprising: at least one input/output device(s) associated with and communicatively connected to a poker player computer terminal; a poker player computer terminal with a graphical user interface (GUI); a server; a database stored on a computer-readable medium; and at least one processor arranged to: display, on a graphical user interface at a player computer terminal, a matrix of potential poker hands; receive, from the player computer terminal, a set of instructions from the player to automatically fold a subset of the matrix of potential poker hands; compare, by a processor, the set of instructions to a poker hand of a player; and execute an instruction, by a processor, to automatically fold the poker hand of the player.

### BRIEF DESCRIPTION OF THE DRAWINGS

FIG. 1 illustrates a graphical user interface display for selecting automatic folding parameters.

### DETAILED DESCRIPTION

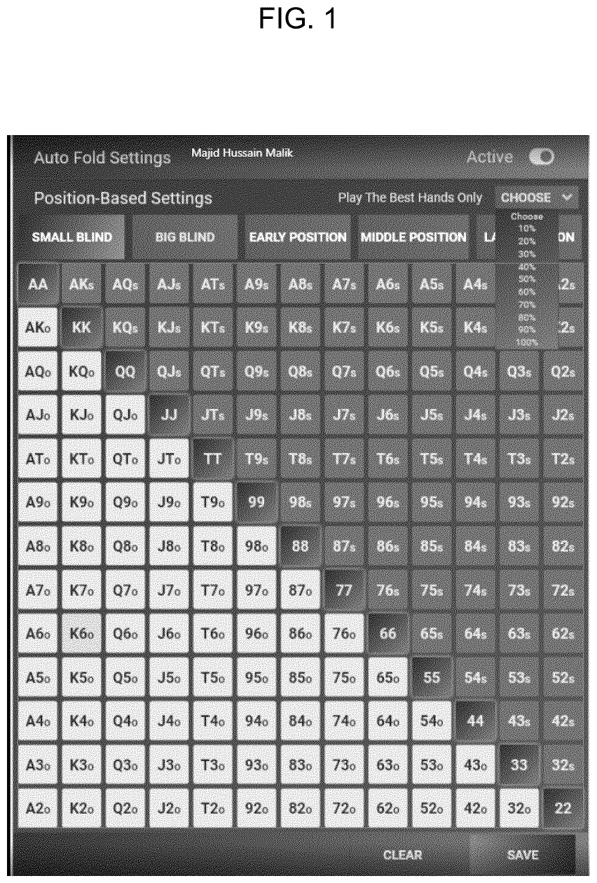

FIG. 1 illustrates a matrix of potential poker hands. In this example, the poker hands are two-card hands as are used in the common poker game Texas Hold ‘Em. In other embodiments, matrices could be customized for other types of poker games including “stud” games where a player does not draw and “draw” games where a player has an option to discard cards from the player's hand and draw additional cards.

The matrix of FIG. 1 is able to receive from the player computer terminal selections from the player in regards to which hands the player would like to fold. It is possible for the player to have different preferences as far as which hands should be folded depending on the position of the player at the poker table.

In FIG. 1, the positions are broken down into small blind, big blind, early position, middle position, and late position. Small blind and big blind positions require a player to bet money prior to viewing the cards dealt to a player, and thus may require different strategies as far as which hand to fold. Early, middle, and late positions share the characteristic that the player is able to fold before betting any money. There, however, may be advantages to late positions for example that cause a player to prefer to fold fewer hands in these positions.

Therefore, separate matrices can be provided for each type of position at the poker table and separate sets of instructions from the player to automatically fold a subset of the matrix of potential poker hands can be received from a player computer terminal with each set corresponding to a type of position at the poker table.

Once instructions are received from a player to automatically fold a subset of potential poker hands, those instructions are stored and executed during the playing of a poker hand. A processor compares the set of instructions for automatically folding hands to a poker hand of a player, given the position where the player is sat for that hand (i.e., big blind, small blind, early position, middle position, late position). Then, an instruction is automatically sent on behalf of the player to the server on which the poker game is running.

It could be possible as well to implement the present invention in a physical casino, in which case a number of embodiments can be used to automatically fold a player's hand. There may be devices integrated with the gaming table, for example, which can automatically read the cards on the table and execute an instruction accordingly.

Automatic fold instructions could be cleared, giving the player the opportunity to reselect new instructions, and as well automatic fold instructions could be toggled on and off according to a button pressed by a player using an input/output device connected to the player's computer terminal. Automatic fold instructions could also be activated or inactivated based on predetermined criteria related to for example the amount of the stakes for the poker game.

The embodiments described above are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A computer-implemented method for automatically folding poker hands, comprising:
displaying, on a graphical user interface at a player computer terminal, a matrix of potential poker hands;
receiving, from the player computer terminal, a set of instructions from the player to automatically fold a subset of the matrix of potential poker hands;
comparing, by a processor, the set of instructions to a poker hand of a player; and
executing an instruction, by a processor, to automatically fold the poker hand of the player.

2. The method according to claim 1, wherein the instruction to automatically fold the poker hand is executed immediately after the hand is dealt.

3. The method according to claim 1, further comprising presenting a switch, on the graphical user interface at the player computer terminal, to enable and disable automatic folding according to the set of instructions.

4. The method of claim 1, further comprising:
displaying, on a graphical user interface at a player computer terminal, buttons corresponding to positions around a poker table; and
receiving, from the player computer terminal, a series of separate sets of instructions from the player to automatically fold a subset of the matrix of potential poker hands based on the position of the player around the poker table.

5. A system, comprising:
at least one input/output device(s) associated with and communicatively connected to a poker player computer terminal;
a poker player computer terminal with a graphical user interface (GUI);
a server;
a database stored on a computer-readable medium; and
at least one processor arranged to:
display, on a graphical user interface at a player computer terminal, a matrix of potential poker hands;
receive, from the player computer terminal, a set of instructions from the player to automatically fold a subset of the matrix of potential poker hands;
compare, by a processor, the set of instructions to a poker hand of a player; and
execute an instruction, by a processor, to automatically fold the poker hand of the player.

6. The system of claim 5, further comprising:
a communications link to one or more additional computer terminals belonging to other players in the poker game.

7. The system of claim 5, further comprising a dealer computer terminal displaying information about the poker player.

8. The system of claim 5, wherein the input/output device is a keyboard.

9. The system of claim 5, wherein is a mouse.

10. The system of claim 5, wherein the input/output device is a touchscreen.
